(19) United States
(12) Patent Application Publication
(10) Pub. No.: US 2003/0068117 A1
(43) Pub. Date: Apr. 10, 2003

(54) Compact, tolerant large-scale mirror-rotation optical cross-connect switch

(76) Inventor: Richard R.A. Syms, Ealing (GB)

Correspondence Address: BROMBERG & SUNSTEIN LLP, 125 SUMMER STREET, BOSTON, MA, 02110-1618, US

(21) Appl. No.: 10/233,054

(22) Filed: Aug. 30, 2002

Related U.S. Application Data
(60) Provisional application No. 60/316,494, filed on Aug. 31, 2001.

(51) Int. Cl. G02B 6/35

(52) U.S. Cl. 385/18

(57) ABSTRACT

The optical design of large-scale mirror-rotation free-space optical cross-connect switches is based on one-or two-dimensional arrays of two-axis micro-electromechanical torsion mirrors. The layout of a compact switch is presented. The parameters of the Gaussian optical beam that maximizes the port count that can be obtained for a given mirror turn angle is identified. The supporting optical system needed to create the desired beam is defined. Scaling laws for the optical path length needed to support a given number of ports are derived. Operating configurations that minimize the effect of static and thermally induced mirror curvature are also identified. The overall design yields a switch layout that is compact and tolerant of mirror distortion.

### PRIORITY

The present invention claims priority from U.S. Provisional Patent Application No. 60/316,494 entitled COMPACT, TOLERANT LARGE-SCALE MIRROR-ROTATION OPTICAL CROSS-CONNECT SWITCH, which was filed on Aug. 31, 2001 in the name of Richard R. A. Syms, and is hereby incorporated herein by reference in its entirety.

### FIELD OF THE INVENTION

The present invention relates generally to optical networking, and more particularly to optical cross-connect switches based upon one-dimensional or two-dimensional arrays of two-axis micro-electro-mechanical torsion mirrors.

### BACKGROUND OF THE INVENTION

The following references are cited throughout the specification using the corresponding reference number enclosed within brackets, and are hereby incorporated herein by reference in their entireties:

[1] Aksyuk V. A., Bishop D. J., Gammel P. L. “Micro machined optical switch” U.S. Pat. No. 5,923,798 July 13 (1999)

[2] Aksyuk V., Barber B., Giles C. R., Ruel R., Stulz L., Bishop D. “Low insertion loss packaged and fibre connectorised MEMS reflective optical switch” Elect. Lett. 34, 1413-1414 (1998)

[3] Aksyuk V., Barber B., Giles C. R., Ruel R. “Low insertion loss packaged and fiber-connectorised Si surface-micromachined reflective optical switch” Solid State Sensor and Actuator Workshop, 79-82 (1998)

[4] Aksyuk V. A. Bishop D. J., Ford J. E., Walker J. A. “Freespace optical bypass-exchange switch” U.S. Pat. No. 5,943,454 August 24 (1999)

[5] Marxer C., de Rooij N. F. “Micro-opto-mechanical 2×2 switch for single-mode fibers based on a plasma-etched silicon mirror and electrostatic actuation” IEEE J. Lightwave Tech. LT-17, 2-6 (1999)

[6] Marxer C., Girardin Y., de Rooij N. F. “4×4 fiber optic matrix switch based on MOEMS” 3rd Int. Conf. on Micro Opto Electro Mechanical Systems Pp 74-75 (1999)

[7] Dautartas M. F., Benzoni A. M., Chen Y. C., Blonder G. E., Johnson B. H., Paola C. R., Rice E., Wong Y. H. “A silicon based moving mirror optical switch” IEEE J. Lightwave Tech. 8, 1075-1085 (1992)

[8] Toshiyoshi H., Fujita H. “Electrostatic micro torsion mirrors for an optical switch matrix” J. Microelectromech. Syst. 5, 231-237 (1996)

[9] Lin L. Y., Goldstein E. L. “Lightwave micromachines for optical crossconnects” Proc. 25th Eur. Conf. on Optical Communication (ECOC) September 26-30, Nice, France, Vol. I Pp 114-117 (1999)

[10] Lee S. S., Huang L.-S., Kim C.-J., Wu M. C. “Free-space fiber-optic switches based on MEMS vertical torsion mirrors” J. Lightwave Tech. LT-17, 7-13 (1999)

[11] Hagelin P. M., Krishnamoorty U., Heritage J. P., Solgaard O. “Scalable optical cross-connect switch using micromachined mirrors” IEEE Photon. Tech. Lett. 12, 882-884 (2000)

[12] Neukermans A. P., Slater T. G. “Micromachined torsional scanner” U.S. Pat. No. 5,629,790 May 13 (1997)

[13] Neukermans A. P., Slater T. G. “Micromachined hinge having an integral torsion sensor” U.S. Pat. No. 5,648,618 July 15 (1997)

[14] Neukermans A. P., Slater T. G., Downing P. “Micromachined members coupled for relative rotation by torsion bars” U.S. Pat. No. 6,044,705 April 4 (2000)

[15] Aksyuk V. A., Bishop D. J. “Self-assembling micro-mechanical device” U.S. Pat. No. 5,994,159 November 30 (1999)

[16] Aksyuk V. A., Pardo F., Bolle C. A., Arney S. C. , Giles C. R., Bishop, D. J. “Lucent Microstar micromirror array technology for large optical crossconnects” Proc. SPIE 4178, 320-324 (2000)

[17] Gasparyan A., Aksyuk V. A., Busch P. A., Arney S. C. “Mechanical reliability of surface-micromachined self-assembling two-axis MEMS tilting mirrors” Proc. SPIE 4180, 86-90 (2000)

[18] Degani O., Socher E., Lipson A., Leitner T., Setter D. J., Kaldor S., Nemirovsky Y. “Pull-in study of an electrostatic torsion microactuator” J. Microelectromech. Syst. 7, 373-379 (1998)

[19] Marcuse D. “Light transmission optics” Van Nostrand Reinhold, New York (1972)

[20] Burns D. M., Bright V. M. “Optical power induced damage to microelectromechanical mirrors” Sensors and Actuators A70, 6-14 (1998)

[21] Spahn, O. B.; Tigges, C.; Shul, R.; Rodgers, S.; Polosky, M. “High optical power handling of pop-up microelectromechanical mirrors” IEEE/LEOS International Conference on Optical MEMS, 2000, pp. 51-52 (2000)

Space-division optical switches are necessary for re-routing signals in optical fiber communications systems. The requirements for such switches include low insertion loss, low cross-talk, insensitivity to wavelength and polarization, high optical power handing capability and scalability to large port counts. According to these criteria, it has been demonstrated that switches based on the deflection of free-space optical beams by small moving mirrors can outperform older forms of switch based on interferometric combination of guided optical waves.

Free-space moving mirror optical switches generally employ mirror devices constructed in silicon or polysilicon using micro-electro-mechanical systems (MEMS) technology, a development of micro-electronic fabrication. Actuation can be by electro-thermal, electrostatic, electromagnetic and piezoelectric methods. Individual MEMS optical switches have been demonstrated as 1×1 reflective switches [1-3], 2×2 reflective switches [4], and 2×2 transmissive switches [5]. In each case, the switching function was performed by insertion or removal of a small mirror.

Switch arrays are constructed from multiple switch elements. The arrangement usually follows one of three configurations: two-dimensional matrices of N×N two-position mirrors, linear arrays of N×N single-axis multiple-position mirrors, and two-dimensional arrays of N²×N² dual-axis multiple-position mirrors.

FIG. 1 shows the arrangement of the first form of optical cross-connect switch. The inputs are provided by a linear array of N optical fibers. Light emerging from the fiber array is collimated by a linear array of lenses into a set of parallel beams that propagate in free space. The outputs are taken from a similar array of fibers, equipped with a similar set of lenses, and designed to accept a similar set of beams. The axes of the input and output fibers are typically arranged at right angles.

The space between the input and output fiber arrays is filled with a set of small movable mirrors, capable of being inserted and removed from the intersection points between the beams at an angle intermediate between the beam directions. A pathway between input fiber i and output fiber j is then established by the insertion of the relevant mirror M(i, j).

N×N free-space mirror insertion optical cross-connect switches have been constructed using mirrors that are translated into position on elastic linear suspensions [6], rotated into position on elastic torsion suspensions [7, 8], or rotated into position on freely-pivoting hinged mounts [9].

FIG. 2 shows the principle of the second form of optical cross-connect switch. The inputs and outputs are again provided by linear arrays of N optical fibers equipped with collimators. However, between the input and output, the beams are reflected from two linear arrays of mirrors. Each individual mirror may be rotated through a variable angle about an axis normal to the figure. A pathway between input fiber i and output fiber j is then established by appropriate angular adjustment of mirror i from the first array and mirror j from the second in a periscope configuration. N×N mirror mirror-rotation free-space optical cross-connect switches have been constructed using MEMS mirrors mounted on elastic torsion suspensions [10,11].

A similar principle is used in the third form of optical cross-connect. The linear arrays of N optical fibers and collimators each replaced with two-dimensional arrays of N² fibers and collimators, and the linear arrays of N single-axis mirrors are replaced by two-dimensional arrays of N² dual-axis mirrors. The required mirror motion may be achieved by mounting the mirror n a nested elastic torsion suspension as shown in FIG. 3. This type of switch is scalable to a higher port count than the two previously described, and has been demonstrated using different forms of MEMS mirror [12-17].

The number of ports that can be supported by a mirror-rotation free-space optical cross-connect switch is limited by the diameter of the beams propagating between the mirrors and the angle through which the mirrors may turn. In electrostatically-driven MEMS mirrors mounted on elastic suspensions, the turn angle is often restricted by a non-linear snap-down phenomenon [18].

In principle, the number of ports that may be supported for a given mirror turn angle can be raised by increasing the separation between the mirror planes, because a mirror on one plane will then subtend a smaller angle at the other. However, this strategy also involves an increase in the optical path. Because the beams are narrow, they diverge as they propagate according to the laws of diffraction, so that an increase in the optical path will cause an increase in the beam diameter. Larger mirrors are then required for efficient reflection, which tends to nullify the effect of placing the mirror planes further apart. Maximization of the port count therefore involves identification of the most effective optical layout rather than an increase in the overall size of the cross-connect.

Any effective optical layout must provide good performance under a variety of operating conditions. For example, MEMS mirrors are often constructed as multi-layers, using a deposited layer of metal (e.g. gold) to improve the reflectivity of a silicon sub-structure. Any stress in the deposited film will cause the mirror surface to become spherically curved. An optical beam reflected from one such mirror may then diverge, so that it is no longer reflected efficiently by the next mirror in the system.

Even if the static curvature may be reduced to zero, a dynamic curvature may arise during use. All metals are imperfect reflectors, and will absorb a fraction of the incident optical power. At the near infrared wavelengths used in optical fiber communication systems, the fraction is 2%-3% for Au metal. The absorbed power will heat the mirror to a temperature set by a balance between the rate of heating and the rate of cooling by through the elastic suspension and the surrounding gas. Since the thermal expansion coefficients of the metal reflector layer and the sub-structure will be different, the mirror will act as a thermal bimorph and become spherically curved. It is therefore necessary to identify optical designs that are relatively immune to static and dynamic curvature.

### SUMMARY OF THE INVENTION

In accordance with one aspect of the invention, the optical design of large-scale mirror-rotation free-space optical cross-connect switches is based on one-or two-dimensional arrays of two-axis micro-electro-mechanical torsion mirrors. The layout of a compact switch is presented. The parameters of the Gaussian optical beam that maximizes the port count that can be obtained for a given mirror turn angle is identified. The supporting optical system needed to create the desired beam is defined. Scaling laws for the optical path length needed to support a given number of ports are derived. Operating configurations that minimize the effect of static and thermally induced mirror curvature are also identified. The overall design yields a switch layout that is compact and tolerant of mirror distortion.

### BRIEF DESCRIPTION OF THE DRAWINGS

In the accompanying drawings:

FIG. 1 shows an N×N mirror-insertion free-space optical cross-connect switch as known in the art;

FIG. 2 shows an N×N mirror-rotation free-space optical cross-connect switch as known in the art;

FIG. 3 shows a movable mirror mounted on a two-axis elastic torsion suspension as known in the art;

FIG. 4 shows a compact layout for a mirror-rotation free-space optical cross-connect switch in accordance with an embodiment of the present invention;

FIG. 5 shows a representation of the variation of beam radius and phase-front curvature of a Gaussian optical beam with propagation distance;

FIG. 6a shows a representation of a symmetric optimized Gaussian optical beam;

FIG. 6b shows a representation of the creation of a symmetric optimized Gaussian beam from an optical fiber;

FIG. 6c shows a representation of an unfolded model of a single connection in an optical cross-connect switch;

FIG. 6d shows a representation of an unfolded model of multiple connections in an optical cross-connect switch;

FIG. 7a shows a plot of the variation of beam radius with position through a single channel of a moving mirror optical cross-connect switch;

FIG. 7b shows a plot of expansion of the variation of beam radius with position through a single channel of a moving mirror optical cross-connect switch near the input fiber;

FIG. 7c shows a plot of expansion of the variation of beam radius with position through a single channel of a moving mirror optical cross-connect switch near the output fiber;

FIG. 8a shows a plot of the variation of beam radius with position through a single channel of a moving mirror optical cross-connect switch, assuming different amounts of convex mirror curvature; and

FIG. 8b shows a plot of the variation of beam radius with position through a single channel of a moving mirror optical cross-connect switch, assuming different amounts of concave mirror curvature.

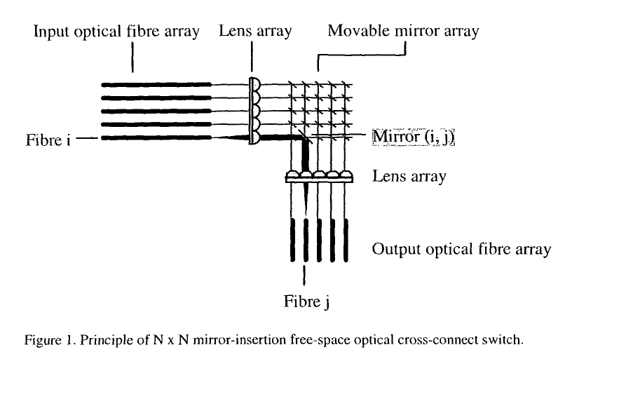

### DETAILED DESCRIPTION OF A PREFERRED EMBODIMENT

An optical design of mirror-rotation free-space optical cross-connect switches is described. A compact cross-connect layout is proposed. The type of optical beam that maximizes the port count that can be obtained for a given mirror turn angle is identified. The supporting optical system needed to create the desired beam above is defined. Scaling laws for the optical path length needed to support a given number of ports are derived. Operating configurations that minimize the effect of static and thermally induced mirror curvature are identified. Because N×N and N²×N² mirror rotation optical cross-connect switches have similar layouts, the designs are relevant to both types of switches.

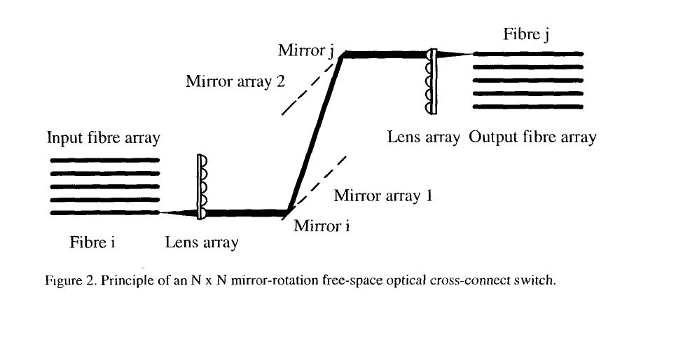

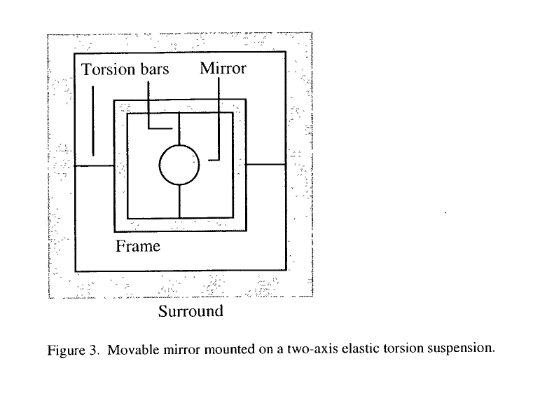

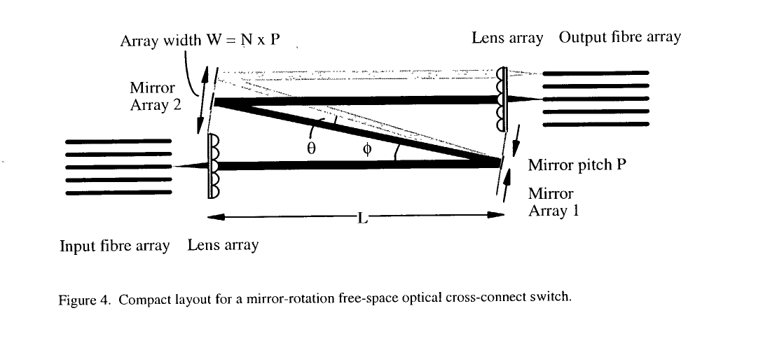

The optical layout of FIG. 2 is not optimal for a mirror-rotation free-space optical cross-connect. FIG. 4 shows an alternative layout, in which the angle φ is minimized. Here, the optical beams strike the mirrors at near-normal incidence, thus minimizing the mirror area required for a given beam diameter. The mirror planes are also placed immediately adjacent to the lens arrays, thus minimizing the distance L. The variation in optical path when the mirrors are arranged to connect different ports is also minimized.

The mirror planes are assumed to consist of either a linear array of N single-axis mirrors or a two-dimensional array of N² mirrors, as appropriate. The mirrors are located on a regular pitch P, so that the overall width of the mirror array is W=NP.

The range and sense of turn angle required from each mirror varies with its position in the array. The central mirror in the array must turn through both positive and negative angles of rotation. The outermost mirrors must turn through approximately twice the maximum angle of the central mirror, but only in one sense.

Each mirror has a maximum turn angle of ±θ about either axis. Assuming that θ is small, so that small-angle approximations can be used, the width W of the mirror array may be related to the distance L and the angle θ by:

W/2≈Lθ (1)

The total optical path ζ between the lenses is then:

θ≈3L≈3NP/2θ (2)

The number of mirrors N across the array can then be related to 74 , ζ and P by:

N≈2θζ/3P (3)

Equation 3 implies that the number of ports N² may be maximized for a given mirror turn angle θ by minimizing the ratio P/ζ. The beams should therefore have the smallest diameter that can be maintained over the distance between the lenses. Suitable beam parameters may be found by considering the propagation of Gaussian beams, solutions to the cylindrical wave equation that are realistic models for many bounded beams.

The electric field of a Gaussian optical beam is a function of its axial co-ordinate z and its radial co-ordinate r, given by [19]:

E(r, z)=A₀exp{−r²/w²}exp{−jk₀r²/2R} (4)

Here, the term exp{−r²/w²} describes the radial variation in amplitude of the beam, while the term exp{−jk₀r²/2R} describes the radial variation in its phase. The parameter w is a characteristic radius at which the amplitude falls to l/e of its maximum value. The parameter R is a characteristic radius that describes the curvature of the phase-front.

Here k₀ is the propagation constant, given by:

k₀=2π/λ (5)

where λ is the optical wavelength.

The values of w and R vary with distance according to:

w²=w₀²{1+(z/z₀)²} (6a)

R=z{1+(z₀/z)²} (6b)

The parameter w₀ represents the minimum beam radius. The minimum radius occurs at the beam waist, which is located at z=0. The parameter z₀ is a characteristic distance measured in the direction of propagation, given by:

z₀=k₀w₀²/2 (7)

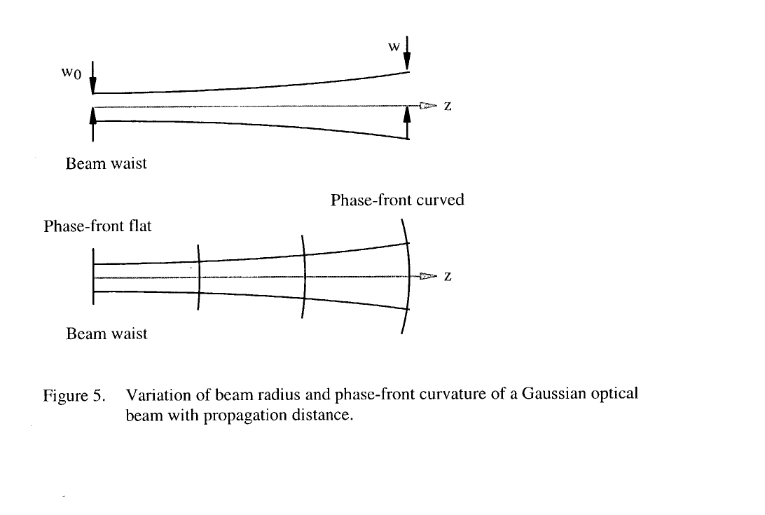

FIG. 5 shows qualitatively how the beam width and phase-front change with distance from the beam waist. Near the waist, the beam is narrow and the phase-front is flat.

To find the parameters of the Gaussian beam that has the smallest final width for a particular propagation distance z, we write the variation in beam width as:

w²=w₀²+4z²/(k₀²w₀²) (8)

Differentiating Equation 7, we obtain:

2wdw/dw₀|_{z=const}=2w₀−8z²/(k₀²w₀³) (9)

At the minimum, the right-hand side of Equation 9 must be zero, so that:

w₀=√{2z/k₀}=√{λz/π} (10)

Equation 10 represents the optimum waist radius w₀ for a Gaussian beam designed to propagate over a distance z from its waist. With this value of w₀, the final value of the beam radius is:

w=w₀√2 (11)

The final value of the beam radius is therefore always related to the initial value by a simple constant, independent of the choice of z. Comparing Equations 6a and 11, the distance z must equal the characteristic distance z₀ for a beam with these parameters.

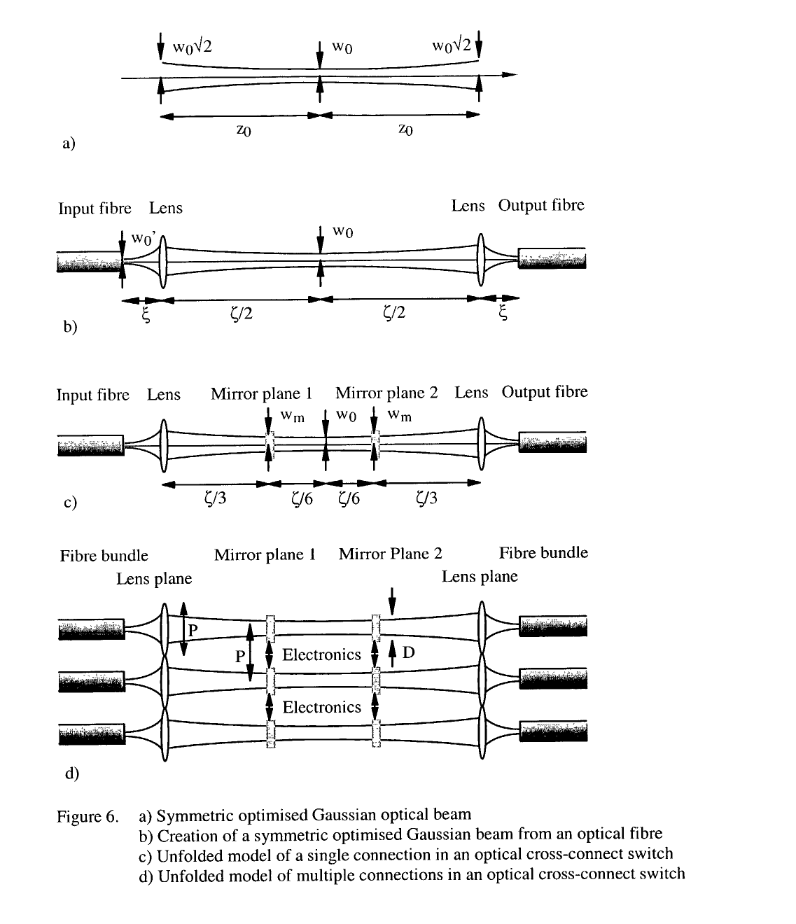

The beam radius may be held within the final value w over twice the distance z by pre-focusing the beam so that it first converges to the waist and then diverges as shown in FIG. 6a. This type of beam is then the narrowest that may propagate between the input and output lenses in a moving mirror optical cross-connect as shown in FIG. 6b. In this case, the distance z must be related to the path length by:

ζ<2z₀ (12)

FIG. 6b also shows an input lens used to convert the beam emerging from an input optical fiber into the desired Gaussian optical beam, and an output lens used to focus this beam back into an output fiber. The properties and placement of the two required lenses must be specified accurately if efficient operation is to be obtained.

Single-mode optical fiber has a characteristic propagation mode that can be approximated well by a Gaussian optical beam with a mode field diameter of ≈8 μm at a wavelength of 1.5 μm. Thus, the fiber emits a Gaussian beam with a waist radius w₀′≈4 μm.

The required lens must therefore transform a Gaussian optical beam with a waist radius w₀′ a distance ξ in front of the lens into one with a waist radius w₀ a distance ζ/2 behind the lens, as shown in FIG. 6b. Analytic relations for the focal length f of a suitable lens are known from earlier studies of Gaussian beams [19], namely:

ζ/2=f±M√{f²−f₀²} (13a)

ξ=f±1/M√{f²−f₀²} (13b)

Here the parameters M and f₀ are given by:

M=w₀/w₀′ (14a)

f₀=(π/λ)w₀w₀′ (14b)

From Equation 13a, the focal length f is the solution of the quadratic equation:

f²{M²−1}+ζf−{²f₀²+ζ²/4}=0 (15)

Once f is known, the distance ξ may then be found by substitution into Equation 13b. By reciprocity, a similar lens may transform the Gaussian beam propagating in the central region of FIG. 6b into an optical field suitable for coupling back into the output fiber. The lenses required for input and output coupling therefore have the same focal length, and the input and output fibers must be placed at the same distances from them.

FIG. 6c shows an unfolded optical model of a single port-to-port connection in a mirror rotation optical cross-connect switch. The two mirrors are placed between the lenses at the intervals shown, so the distance zₘ from the beam waist to each mirror is:

zₘ=ζ/6=z₀/3 (16)

From Equation 6a, the beam radius wₘ at the mirror must therefore be given by

wₘ=w₀√{1+1/9}=1.054w₀. (17)

From Equation 17, the beam radius at each mirror is therefore smaller than the maximum value w=w₀√2 obtained at the input and output lenses. If an entire mirror rotation optical cross-connect switch is constructed from an array of similar optical connections, as shown in the unfolded model of FIG. 6d, there will therefore be sufficient space on the mirror planes between the mirror elements to allow local placement of control electronics.

FIG. 6d shows adjacent channels of the cross-connect on a pitch P. The value of P is governed by the requirement that the optical beams identified above may be able to pass through each channel without significant attenuation.

Equation 4 shows that the amplitude of a Gaussian optical beam is maximum at r=0, and falls gradually to zero as r increases. When the beam is passed through an aperture of finite radius ρ, as provided by a lens or a mirror of finite size, some power must necessarily be lost. The attenuation can be estimated by integrating the power lying outside this radius. For ρ=w, the loss is 0.6315 dB, and for ρ=w√2, the loss is 0.0803 dB. The attenuation may therefore be reduced to a suitable value by taking the radii of any apertures in the system to be a suitably large multiple α of the beam radius w.

The lens pitch P and mirror diameter D in a mirror rotation optical cross-connect should therefore be chosen so that:

P=2αw (18a)

D=2αwₘ (18b)

Combining Equation 3 with Equations 10, 11, 12 and 18a, a closed-form expression for the number of mirrors N across the array may then be obtained as:

N=(θ/3α)√(πζ/λ) (19)

For a given wavelength λ, mirror turn angle θ, and optical path length ζ, and assuming a particular value for the parameter α, Equation 19 represents the upper limit to the port count that may be achieved in an N×N mirror rotation optical cross-connect switch.

Alternatively, Equation 19 may be inverted to determine the path length required in an N×N mirror rotation optical cross-connect switch for a given wavelength λ and mirror turn angle θ, assuming a particular value for the parameter α, as:

ζ=9α²N²λ/πθ² (20)

Equation 20 shows that the path length ζ must increase with the square of the number of ports N in an N×N mirror rotation optical cross-connect switch.

Because the layouts of N×N and N²×N²mirror rotation optical cross-connect switches are similar, the design formulae above are relevant to both types of switch. Squaring Equation 19 yields:

N²=(π/9α²λ)ζθ² (21)

Equation 21 is a similar limit to the port count that may be achieved in an N²×N² mirror rotation optical cross-connect switch.

The path length ζrequired in an N²×N² mirror rotation optical cross-connect switch may again be obtained from Equation 20. In this case, ζ must increase linearly with the number of ports N².

This result shows that an N²×N² mirror rotation optical cross-connect switch is generally a more effective design than a similar N×N switch, because the path length required to sustain a similar number of ports is always smaller (unless N=1). The difference in path length may be considerable for large N.

As an example, we calculate the parameters of an N²×N² mirror rotation optical cross-connect switch, assuming that the mirror turn angle is limited to 0.1 rad or 6°. The switch is designed to operate at a wavelength of 1.5 μm, using optical fibers whose mode field radius is 4 μm. The number of ports is N²=1024, so that N=32. The results for two different values of α are as follows:

| | | α = √2 | | α = 1 | |
|---|---|---|---|---|---|
| Total path length | ζ | 0.88 | m | 0.44 | m |
| Beam radius at waist | w₀ | 0.458 | mm | 0.324 | mm |
| Beam radius on mirror | wₘ | 0.483 | mm | 0.342 | mm |
| Mirror diameter | D | 1.366 | mm | 0.684 | mm |
| Beam radius at lens | w | 0.648 | mm | 0.458 | mm |
| Lens diameter | P | 1.833 | mm | 0.916 | mm |
| Lens focal length | f | 5.39 | mm | 3.81 | mm |
| Fiber-lens separation | ξ | 5.43 | mm | 3.84 | mm |

It should be noted that the system with the larger value of α will have lower loss due to the effect of any apertures, but a longer optical path length.

The operation of an optical system of this type may be verified by simulation. The propagation of a Gaussian optical beam is conveniently modelled in terms of a complex beam parameter q=z+jz₀[19], which allows the field in Equation 4 to be written as:

E(r,z)=A₀exp{−jk₀r²/2q} (22)

Here, the beam width w and the radius of curvature R of the phase-front are related to the parameter q by:

1/w²=−(k₀/2)Im(1/q) (23a)

1/R=Re(1/q) (23b)

The effect of propagating the beam through a distance z, or through a lens of focal length f, is to modify the complex beam parameter. The new value q′ is given by [19]:

q′={aq+b)/{cq+d} (24)

Here the coefficients a, b, c and d take the following values:

| | a | b | c | d |
|---|---|---|---|---|
| Propagation through a distance z | 1 | z | 0 | 1 |
| Propagation through a lens | 1 | 0 | −1/f | 1 |

Equations 23a, 23b, 24 and 25 may be used to simulate beam propagation through an unfolded optical cross-connect system. If the mirror surfaces are spherically curved, their effect may be modelled by replacing the mirrors with equivalent spherical lenses. A lens of focal length r/2 may simulate a concave mirror of radius r, and so on.

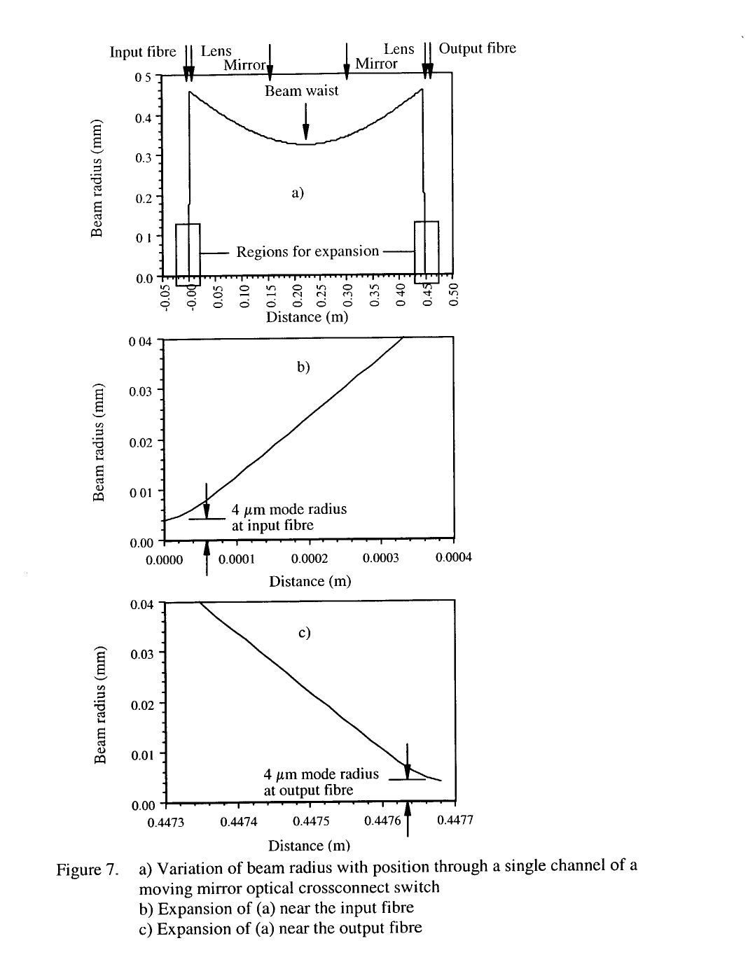

For example, FIG. 7 shows the variation of beam radius with position in an unfolded model of a single channel of an N²×N² mirror rotation optical cross-connect switch with the parameters of Table I, assuming that α=1. FIG. 7a shows the variation through the entire system from input fiber to output fiber, and FIGS. 7b and 7c show enlarged details near the input and output fibers, respectively. This numerical simulation confirms all the essential details of the design formulae given above. The beam radius variation between the lenses is as expected, and the mode size at the output fiber is exactly the value at the input fiber.

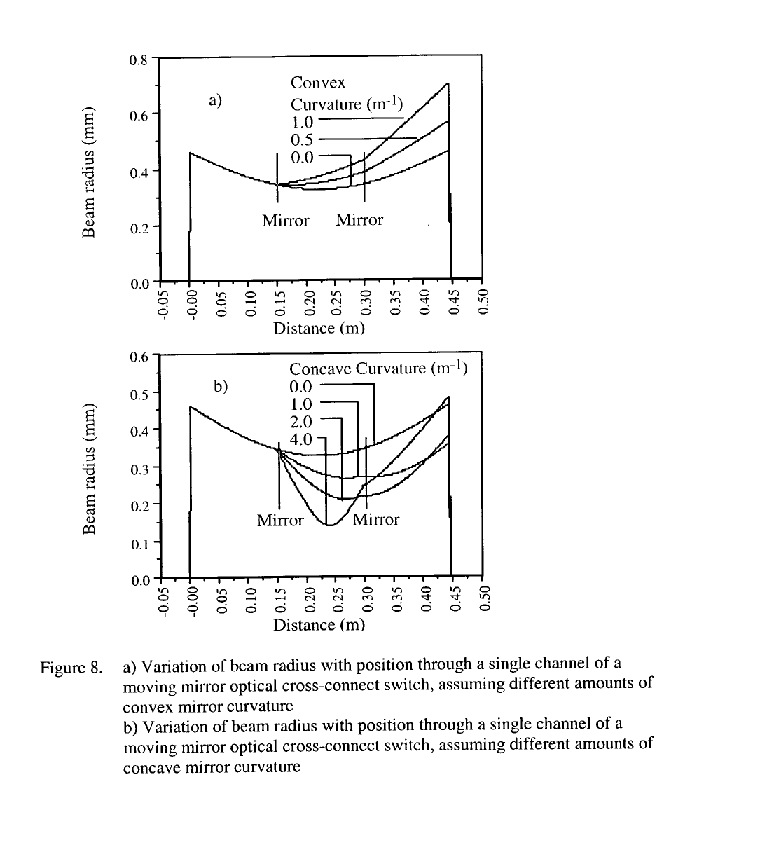

Because the mirrors are flat in the example above, they do not affect the propagation of the beam in the model of FIG. 7. However, the use of a multi-layer MEMS mirror construction, typically consisting of a deposited layer of high-reflectivity metal of a silicon sub-structure, may result in spherical curvature of the mirrors. FIG. 8 shows additional simulations of the system in FIG. 7, assuming that the reflective surface is a) convex and b) concave.

Generally, the effect of convex curvature (FIG. 8a) is to increase the beam divergence at each mirror. As a result, the beam radius at the output lens typically becomes too large to pass through the finite aperture of the output lens without attenuation.

Generally, the effect of concave curvature (FIG. 8b) is to decrease the beam divergence, partially focussing the beam. If the curvature is too large, the focussing effect is too great, and the beam starts to diverge significantly before it reaches the output lens. In this case, the beam radius at the output lens will typically become too large to pass through the finite aperture of the output lens without attenuation. However, over the range of curvature shown, the beam radius is held within suitable limits, and attenuation due to the finite aperture of the output lens is avoided.

The usable curvature range is approximately 4.0 m⁻¹ in this example. More generally, it may be shown that the usable curvature range is inversely proportional to the optical path length ζ.

This behaviour allows the design of N×N and N²×N² mirror rotation optical cross-connect switches that are tolerant to a) variations in the stress of the deposited reflective layer and b) heating during operation.

Variations in the stress of the deposited reflective layer cause variations in the curvature of the mirror. Most metals deposited by sputtering have a tensile stress. The resulting mirror surface is concave, and the radius of curvature may be adjusted by altering the thickness of the deposited layer.

Heating during operation can arise by variations in the ambient temperature, by the action of adjacent electronics, or through absorption of a fraction of the incident optical power by the metal reflector layer. At the near infrared wavelengths used in optical fiber communication systems, the fractional absorption is 2%-3% for Au metal.

The effect is to cause a net expansion of the deposited layer compared with the sub-structure, because of the relatively high thermal expansion coefficient of most metals. As a result, the curvature of the mirror becomes increasingly convex.

In each case, an improvement in performance may be obtained by biasing the curvature of the mirrors in a concave manner.

a) To minimize the effect of random variations in the stress of the deposited reflective layer, the curvature imposed on the mirrors should be biased to half of the maximum range estimated from FIG. 8b (or the corresponding amount for a different optical path length). In this case, the variation in curvature that may be tolerated before the total curvature lies outside the range giving low attenuation may be maximized.

To minimize the effect of differential thermal expansion caused by heating, the curvature imposed on the mirrors should be biased to the maximum range estimated from FIG. 8b (or the corresponding amount for a different optical path length). In this case, the variation in curvature that may be tolerated before the total curvature lies outside the range giving low attenuation may be maximized.

The present invention may be embodied in other specific forms without departing from the true scope of the invention. The described embodiments are to be considered in all respects only as illustrative and not restrictive.

What is claimed is:

1. A mirror-rotation free-space optical cross-connect switch having a substantially optimum folded optical path, the mirror-rotation free-space optical cross-connect switch comprising:
a plurality of input lenses;
a plurality of output lenses;
a first plurality of rotatable mirrors positioned adjacent to the plurality of output lenses; and
a second plurality of rotatable mirrors positioned adjacent to the plurality of input lenses, wherein:
each of the plurality of input lenses is operably coupled to direct an optical beam from an input fiber to a predetermined one of the first plurality of rotatable mirrors;
each of the first plurality of rotatable mirrors is configurable to direct the corresponding optical beam to a selected one of the second plurality of rotatable mirrors;
each of the second plurality of rotatable mirrors is configurable to direct the corresponding optical beam to a predetermined one of the plurality of output lenses; and
each of the plurality of output lenses is operably coupled to direct the corresponding optical beam to an output fiber.
